(19) United States
(12) Patent Application Publication
(10) Pub. No.: US 2016/0226927 A1
(43) Pub. Date: Aug. 4, 2016

(54) FIELD DEVICE

(71) Applicant: Azbil Corporation, Tokyo (JP)

(72) Inventors: Makoto TAKAHASHI, Tokyo (JP); Naoki OTSUKA, Tokyo (JP)

(73) Assignee: Azbil Corporation

(21) Appl. No.: 15/007,832

(22) Filed: Jan. 27, 2016

(30) Foreign Application Priority Data
Jan. 29, 2015 (JP) 2015-014986

(51) Int. Cl. H04L 29/06

(52) U.S. Cl. CPC H04L 65/1069

(57) ABSTRACT

To immediately reflect replacement of a field device in a network, a field device is provided. When a field device is newly connected to a low-order network due to replacement or the like, a state in which there is no connection changes to a state in which a connection portion has connected to the network and the change is detected by a connection detecting portion. This causes an address information transmitting portion to transmit an IP address and a MAC address stored in a network information storing portion to the low-order network and they reach a router. In the router, a table containing correspondence between set MAC addresses and IP addresses is updated based on the new information.

### CROSS-REFERENCE TO RELATED APPLICATION

The present application claims the benefit of and priority to Japanese Patent Application No. 2015-014986, filed on Jan. 29, 2015, the entire contents of which are incorporated by reference herein.

### TECHNICAL FIELD

The present invention relates to a field device to be connected to a controlling system via an Ethernet (registered trademark) network.

### BACKGROUND ART

A controlling system including a control apparatus or instrument controlling device is used to monitor and control, for example, ancillary facilities of buildings and to control plants (see PTL 1). The controlling system exchanges signals with field devices such as process devices and various types of sensors installed in a field connected via a network.

Such a controlling system generally uses the standard (international standard) in which signals (referred to as “4-20 mA” signals) having electric current from 4 mA to 20 mA are used for the network through which field devices are connected to the controlling system. In this network, an electric current value (4 to 20 mA) was formerly used to represent the value of a sensor (field device) and the percentage (0 to 100%) of valve opening (primary measurement value).

However, network systems employing digital signals have been used recently because there is the need to treat more information such as temperature information for temperature pressure correction in a barometer and setting parameters of a field device. For example, there is a HART (Highway Addressable Remote Transducer, registered trademark) communication system in which digital signals are superimposed on the above analog control signals.

In such a network using digital signals, Ethernet (Ethernet/IEEE802.3u, 100BASE-T, registered trademark) is used as the communication system. In Ethernet, IP addresses (Internet Protocol Address) are assigned to identify devices in a network. In addition, MAC (Media Access Control) addresses specific to devices are also used. In such communication, for example, a router manages a table containing correspondence between MAC addresses and IP addresses of installed devices.

However, field devices used for a network using “4-20 mA” signals described above have only necessary functions to reduce power consumption. Accordingly, even in a situation in which an Ethernet network is applied, such field devices often have only passive functions that return a response with respect to a command request.

### PRIOR ART DOCUMENTS

### Patent Documents

[PTL 1] JP-A-2012-014388

### SUMMARY OF THE INVENTION

### Problems to be Solved by the Invention

In the above network structure, when a field device is replaced due to a failure or the like, the router keeps the table storing correspondence between MAC addresses and IP addresses for a certain period of time, so the replacement of the field device is not immediately reflected in the network. Accordingly, recovery of communication between the replacing field device and the controlling device (high-order host) may take time, resulting in a delay in the start of control or the like.

The invention addresses the above problems with an object of immediately reflecting replacement of a field device in the network.

### Means for Solving the Problems

According the invention, there is provided a field device to be connected to a controlling system via an Ethernet network, the field device including, network connecting means for connecting to the network, a network information storing portion in which an IP address and a MAC address of the field device are stored, and address information transmitting means transmitting the IP address and the MAC address stored in the network information storing portion to the network.

The field device further includes connection detecting means for detecting a change from a state in which there is no connection to the network to a state in which the connecting means has connected to the network, in which the address information transmitting means transmits the IP address and the MAC address to the network when the connection detecting means detects the change.

The field device further includes an input interface receiving an instruction via an operation by an operator, in which the address information transmitting means transmits the IP address and the MAC address to the network when the input interface receives the instruction.

The field device further includes reply detecting means for detecting a reply in response to transmission from the field device, in which the address information transmitting means performs transmission of the IP address and the MAC address stored in the network information storing portion to the network at predetermined time intervals and, when the reply detecting means receives a reply in response to the transmission, stops the transmission of the IP address and the MAC address to the network.

### Advantage of the Invention

As described above, the invention provides the beneficial effect of immediately reflecting replacement of a field device in the network.

### BRIEF DESCRIPTION OF THE DRAWINGS

FIG. 1 is a structural diagram illustrating the structure of a field device 101 according to embodiment 1 of the invention.

FIG. 2 is a structural diagram illustrating the structure of a field device 201 according to embodiment 2 of the invention.

FIG. 3 is a structural diagram illustrating the structure of a field device 301 according to embodiment 3 of the invention.

### MODE FOR CARRYING OUT THE INVENTION

Embodiments of the invention will be described below with reference to the drawings.

### Embodiment 1

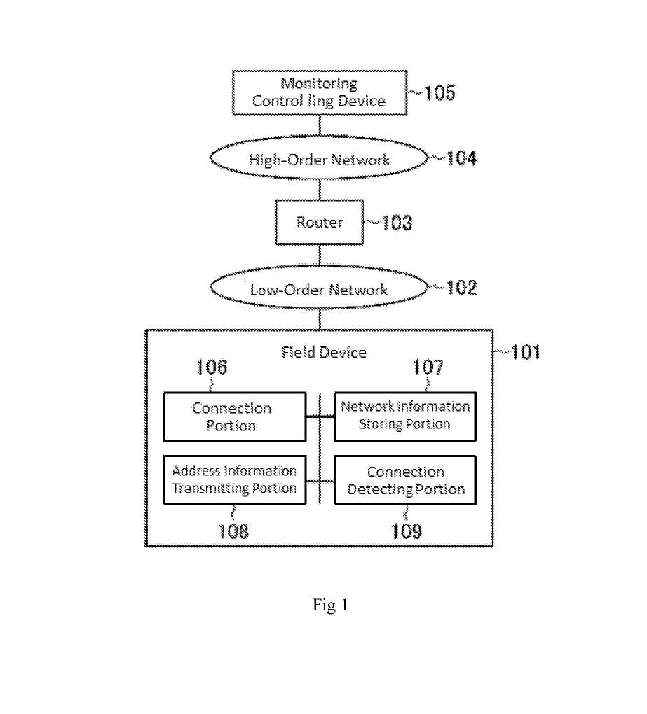

First, embodiment 1 of the invention will be described with reference to FIG. 1. FIG. 1 is a structural diagram illustrating the structure of a field device 101 according to embodiment 1 of the invention. First, the field device 101 is connected to a controlling system including a monitoring controlling device 105 via a low-order network 102, a router 103, and a high-order network 104 using a connection portion 106. Although a plurality of field devices are connected to the low-order network 102, they are not illustrated in FIG. 1. In addition, although a plurality of low-order networks are connected to the high-order network via individual routers, they are not illustrated in FIG. 1.

The field device 101 is a process instrument or one of various types of sensors used to monitor and control ancillary facilities of buildings or control plants and the monitoring controlling device 105 monitors and controls the field device 101. The field device 101 returns requested information based on a control instruction from the monitoring controlling device 105.

The field device 101 includes a network information storing portion 107 and an address information transmitting portion 108 in addition to the above components.

The network information storing portion 107 stores an IP address and a MAC address of the field device. The address information transmitting portion 108 transmits the IP address and the MAC address stored in the network information storing portion 107 to the low-order network 102.

In addition, the field device 101 according to embodiment 1 includes a connection detecting portion 109 detecting a change from a state in which there is no connection to the low-order network 102 to a state in which the connection portion 106 has connected to the network. In embodiment 1, when the connection detecting portion 109 detects the above change, the address information transmitting portion 108 transmits the IP address and the MAC address stored in the network information storing portion 107 to the network.

In embodiment 1, when the field device 101 is newly connected to the low-order network 102 due to replacement or the like, a state in which there is no connection changes to a state in which the connection portion 106 has connected to the network and the change is detected by the connection detecting portion 109. This causes the address information transmitting portion 108 to transmit the IP address and the MAC address stored in the network information storing portion 107 to the low-order network 102 and they reach the router 103.

The address information transmitting portion 108 transmits the IP address and the MAC address by, for example, broadcasting a dummy frame to the low-order network 102. Alternatively, the address information transmitting portion 108 transmits the IP address and the MAC address by, for example, transmitting a dummy frame addressed to the router 103 or the monitoring controlling device 105 to the low-order network 102. Alternatively, the address information transmitting portion 108 transmits the IP address and the MAC address by, for example, transmitting a dummy frame addressed to the domain of the monitoring controlling device 105 to the low-order network 102. Alternatively, the address information transmitting portion 108 transmits the IP address and the MAC address by, for example, transmitting an ARP packet of Gratuitous ARP (Address Resolution Protocol) or the like to the low-order network 102.

As described above, the IP address and the MAC address of the field device are transmitted, so that the table containing the correspondence between set MAC addresses and set IP addresses is updated based on the new information in, for example, the router 103. As a result, replacement of the field device 101 is immediately reflected in the low-order network 102, so communication between the field device 101 and the monitoring controlling device 105 resumes without stagnation. In addition, since communication between the field device 101 and the monitoring controlling device 105 immediately resumes, obstruction of the monitoring and controlling of facilities or the controlling of plants is prevented.

### Embodiment 2

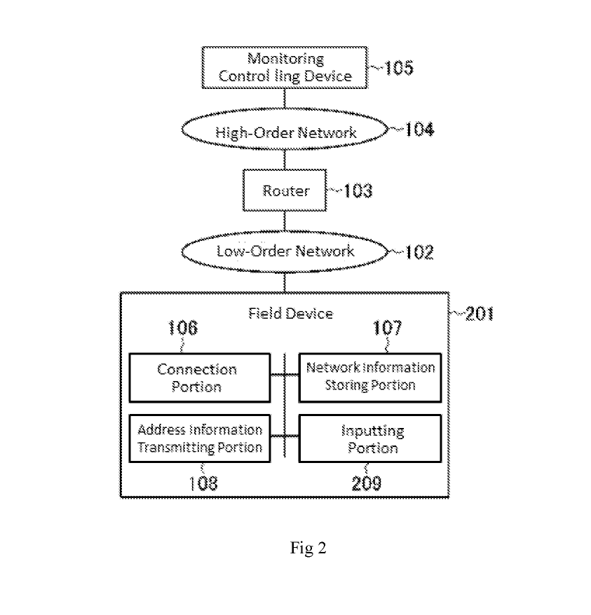

Next, embodiment 2 of the invention will be described with reference to FIG. 2. FIG. 2 is a structural diagram illustrating the structure of a field device 201 according to embodiment 2 of the invention. First, as in embodiment 1 described above, the field device 201 is connected to a controlling system including the monitoring controlling device 105 via the low-order network 102, the router 103, and the high-order network 104 using the connection portion 106.

The field device 201 is a process instrument or one of various types of sensors used to monitor and control ancillary facilities of buildings or control plants and the monitoring controlling device 105 monitors and controls the field device 201. The field device 201 returns requested information based on a control instruction from the monitoring controlling device 105.

In addition, as in embodiment 1 described above, the field device 201 includes the network information storing portion 107 and the address information transmitting portion 108.

In addition, the field device 201 according to embodiment 2 has an inputting portion (input interface) 209 receiving an instruction via an operation by the operator. In embodiment 2, the address information transmitting portion 108 transmits the IP address and the MAC address stored in the network information storing portion 107 to the network when the inputting portion 209 receives an instruction via an operation by the operator.

In embodiment 2, when the field device 201 is newly connected to the low-order network 102 due to replacement or the like, if an instruction is received through an operation of the inputting portion 209 by the operator, the address information transmitting portion 108 transmits the IP address and the MAC address stored in the network information storing portion 107 to the low-order network 102 and they reach the router 103.

The address information transmitting portion 108 transmits the IP address and the MAC address by, for example, broadcasting a dummy frame to the low-order network 102. Alternatively, the address information transmitting portion 108 transmits the IP address and the MAC address by, for example, transmitting a dummy frame addressed to the router 103 or the monitoring controlling device 105 to the low-order network 102. Alternatively, the address information transmitting portion 108 transmits the IP address and the MAC address by, for example, transmitting a dummy frame addressed to the domain of the monitoring controlling device 105 to the low-order network 102. Alternatively, the address information transmitting portion 108 transmits the IP address and the MAC address by, for example, transmitting an ARP packet of Gratuitous ARP or the like to the low-order network 102.

As described above, the IP address and the MAC address of the field device are transmitted, so that the table containing the correspondence between set MAC addresses and set IP addresses is updated based on the new information in, for example, the router 103. As a result, replacement of the field device 201 is immediately reflected in the low-order network 102, so communication between the field device 201 and the monitoring controlling device 105 resumes without stagnation. In addition, since communication between the field device 201 and the monitoring controlling device 105 immediately resumes, obstruction of the monitoring and controlling of facilities or the controlling of plants is prevented.

### Embodiment 3

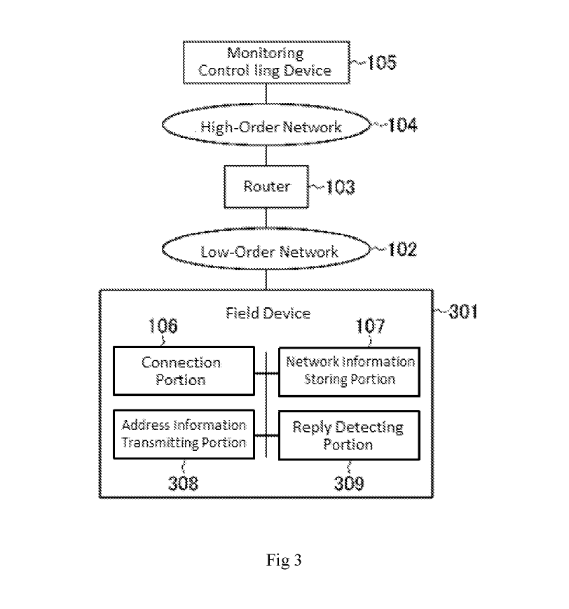

Next, embodiment 3 of the invention will be described with reference to FIG. 3. FIG. 3 is a structural diagram illustrating the structure of a field device 301 according to embodiment 3 of the invention. First, as in embodiments 1 and 2 described above, the field device 301 is connected to a controlling system including the monitoring controlling device 105 via the low-order network 102, the router 103, and the high-order network 104 using the connection portion 106.

The field device 301 is a process instrument or one of various types of sensors used to monitor and control ancillary facilities of buildings or control plants and the monitoring controlling device 105 monitors and controls the field device 301. The field device 301 returns requested information based on a control instruction from the monitoring controlling device 105.

In addition, the field device 301 includes the network information storing portion 107 as in embodiments 1 and 2 described above.

In addition, the field device 301 according to embodiment 3 includes a reply detecting portion 309 detecting a replay in response to transmission from the field device 301. In addition, in embodiment 3, an address information transmitting portion 308 transmits the IP address and the MAC address stored in the network information storing portion to the network at predetermined intervals. For example, the address information transmitting portion 308 transmits the IP address and the MAC address at intervals of five seconds. When the reply detecting portion 309 receives a replay in response to the transmission, the address information transmitting portion 308 stops transmitting the IP address and the MAC address to the network.

In embodiment 3, the field device 301 starts transmitting the IP address and the MAC address stored in the network information storing portion at predetermined time intervals from the point of time when the field device 301 is newly connected to the low-order network 102 due to replacement or the like. This causes the address information transmitting portion 308 to transmit the IP address and the MAC address of the field device 301 to the low-order network 102 and they reach the router 103.

The address information transmitting portion 308 transmits the IP address and the MAC address by, for example, broadcasting a dummy frame to the low-order network 102. Alternatively, the address information transmitting portion 308 transmits the IP address and the MAC address by, for example, transmitting a dummy frame addressed to the router 103 or the monitoring controlling device 105 to the low-order network 102. Alternatively, the address information transmitting portion 308 transmits the IP address and the MAC address by, for example, transmitting a dummy frame addressed to the domain of the monitoring controlling device 105 to the low-order network 102. Alternatively, the address information transmitting portion 308 transmits the IP address and the MAC address by, for example, transmitting an ARP packet of Gratuitous ARP or the like to the low-order network 102.

As described above, the IP address and the MAC address of the field device are transmitted, so that the table containing the correspondence between set MAC addresses and set IP addresses is updated based on the new information in, for example, the router 103.

As a result, replacement of the field device 301 is immediately reflected in the low-order network 102, so communication between the field device 301 and the monitoring controlling device 105 resumes without stagnation. In addition, since communication between the field device 301 and the monitoring controlling device 105 immediately resumes, obstruction of the monitoring and controlling of facilities or the controlling of plants is prevented.

When a replay in response to the transmitted dummy frame is received by the field device 301 (connection portion 106) and detected by the reply detecting portion 309, the address information transmitting portion 308 stops transmitting the IP address and the MAC address to the network, so the transmission of an unnecessary dummy frame is prevented.

As described above, the IP address and the MAC address of a field device is transmitted to the network in the invention, so replacement of a field device is immediately reflected in the network.

The invention is not limited to the above embodiments and it is appreciated that those skilled in the art may perform many modifications and combinations within the technical concept of the invention.

### DESCRIPTION OF REFERENCE NUMERALS AND SIGNS

101, 201, 301: field device, 102: low-order network, 103: router, 104: high-order network, 105: monitoring controlling device, 106: connection portion, 107: network information storing portion, 108, 308: address information transmitting portion, 109: connection detecting portion, 209: inputting portion (input interface), 309: reply detecting portion.

1. A field device to be connected to a controlling system via an Ethernet network, the field device comprising:
a connection portion configured to connect to the network;
a network information storing portion in which an IP address and a MAC address of the field device are stored; and
an address information transmitting portion configured to transmit the IP address and the MAC address stored in the network information storing portion to the network.

2. The field device according to claim 1, further comprising:
a connection detecting portion configured to detecta change from a state in which there is no connection to the network to a state in which the connection portion has connected to the network;
wherein the address information transmitting portion transmits the IP address and the MAC address to the network when the connection detecting portion detects the change.

3. The field device according to claim 1, further comprising:
an input interface receiving an instruction via an operation by an operator,
wherein the address information transmitting portion transmits the IP address and the MAC address to the network when the input interface receives the instruction.

4. The field device according to claim 1, further comprising:
a reply detecting portion configured to detec a reply in response to transmission from the field device,
wherein the address information transmitting portion performs transmission of the IP address and the MAC address stored in the network information storing portion to the network at predetermined time intervals and, when the reply detecting portion receives a reply in response to the transmission, stops the transmission of the IP address and the MAC address to the network.
